(19) United States
(12) Patent Application Publication
(10) Pub. No.: US 2026/0246253 A1
(43) Pub. Date: Aug. 20, 2026

(54) MULTI-STACK, OPEN TRACK BUSWAY CONSTRUCTION

(71) Applicant: VERTIV CORPORATION, Westerville, OH (US)

(72) Inventors: Adrian Sheridan, Ras Al Khaimah (AE); Marc A. Dawson, Culmore (IE); Stephen Kerr, Killaloo (IE); Sreehari Thekkekara Katupurathillam, Ras Al Khaimah (AE); Karol McDermott, Moville (IE)

(21) Appl. No.: 19/465,277

(22) Filed: Jan. 30, 2026

Related U.S. Application Data
(60) Provisional application No. 63/760,447, filed on Feb. 19, 2025.

(51) Int. Cl. H02G 5/02

(52) U.S. Cl. CPC H02G 5/025

(57) ABSTRACT

A busway system includes multiple busways, one or more stack joint packs, and one or more mechanical joint blocks. The multiple busways form a stack of busways with each busway including a respective plurality of busway segments. Each busway segment includes multiple buses and a segment housing configured to carry and electrically insulate the buses from one another. One or more busways define an open track therein to facilitate electrical coupling with one or more tap-off boxes. The one or more stack joint packs electrically couple with the busways with each joint stack pack selectably electrically interconnecting a plurality of pairs of busway segments. The one or more mechanical joint blocks are mounted between an adjacent pair of the busways, such as with a first busway located above and carrying a second busway via a corresponding mechanical joint block.

### CROSS REFERENCE TO RELATED APPLICATION

This nonprovisional application claims the benefit of priority of U.S. Application No. 63/760,447 filed Feb. 19, 2025, which is hereby incorporated by reference in its entirety.

### BACKGROUND

Data centers are required to support rapidly increasing computational demand driven by high-performance computing, artificial intelligence, and data-intensive applications. As a result, data center operators must continuously adapt their infrastructure to accommodate higher power densities, changing equipment layouts, and evolving operational requirements. Electrical power distribution systems play a critical role in enabling this adaptability.

Existing open channel busway products can provide a single open track busway with a maximum International Electrotechnical Commission (IEC) rating of 1000 Amps (A). Even upon increasing the housing size to accommodate larger conductors, the IEC rating may be improved to 1400 A. However, as Graphics Processing Unit (GPU) power demands continue to rise (e.g., Nvidia Blackwell B200™ GPU), the existing 1000 A amperage open channel busway may fall short, necessitating users currently to resort to enclosed fixed-position tap-off slot busways, which compromises flexibility and scalability.

There is therefore a growing need for interconnectable busway systems that provide enhanced flexibility and scalability within data center environments. Such systems should enable seamless electrical and mechanical interconnection between busway segments, allow for straightforward extension or reconfiguration as power demands change, and support varying power capacities without requiring substantial redesign of the overall distribution network.

### SUMMARY

In an embodiment of the present disclosure, a busway system may include multiple busways, one or more stack joint packs for interconnecting lengths of busways, and one or more mechanical joint blocks for connecting busways. The multiple busways may define a stack of busways, with each busway including a respective plurality of busway segments. Each busway may include multiple buses and a segment housing, the segment housing configured to carry the buses and electrically insulate the buses from one another and from a surrounding environment. In embodiments, one or more busways define an open track therein, with each open track configured to facilitate electrical coupling with at least one tap-off box. In embodiments, the one or more stack joint packs electrically couple with the busways, with each joint stack pack selectably electrically interconnecting pairs of busway segments associated with the respective busways. The one or more mechanical joint blocks may be mounted between an adjacent pair of the busways, with a first busway located above the second busway of the adjacent pair of the busways. Each mechanical joint block may be configured to carry the second busway below the first busway.

According to a first aspect, the busway system includes a plurality of busways arranged in a stacked configuration, each busway comprising a plurality of busway segments arranged end-to-end, one or more stack joint packs electrically coupling the plurality of busway segments, and one or more mechanical joint blocks mounted between adjacent busways of the plurality of busways.

In some embodiments, each busway segment includes a plurality of electrical buses, and a segment housing configured to contain the plurality of electrical buses and electrically insulate the plurality of electrical buses from one another.

In some embodiments, the stacked configuration includes at least two busways and at least four busway segments.

In some embodiments, the stacked configuration includes at least three busways and at least six busway segments.

In some embodiments, at least one of the plurality of busways defines an open track extending along a length of the busway configured to facilitate electrical coupling between the busway and one or more tap-off boxes.

In some embodiments, each stack joint pack is selectively installable and removable to enable reconfiguration of electrical interconnections between the busway segments, and each stack joint pack is configured to electrically interconnect corresponding electrical buses of adjacent busway segments.

In some embodiments, the stacked configuration includes a vertical stack in which an upper busway mechanically supports a lower busway via a plurality of the mechanical joint blocks.

In some embodiments, each mechanical joint block includes a first joint block section, a second joint block section, one or more mounting plates, a section connector extending through the first joint block section, the section joint block section, and the one or more mounting plates to secure the mechanical joint block as an assembled unit, a plurality of grab screws, and a plurality of distal face mounting ports.

In some embodiments, each mechanical joint block includes a first joint block section, a second joint block section, one or more mounting plates, a plurality of grab screws, and a plurality of distal face mounting ports, wherein the first joint block section and the second joint block section are separate or integrally formed.

In some embodiments, the plurality of busways includes a lower busway having an open track configuration and one or more upper busways each having a closed track configuration.

In some embodiments, each busway is rated by Underwriter's Laboratory (UL) to carry a current of at least 1600 amps (A) due to the one or more stack joint packs being electrically coupled with the plurality of busway segments.

According to another aspect a busway system includes a plurality of stacks of busway segments, each stack comprising at least two busway segments arranged in a vertical stacked relationship, one or more mechanical joint blocks mechanically coupling adjacent busway segments within each stack of busway segments, and one or more stack joint packs positioned between longitudinally adjacent stacks of busway segments, wherein each stack joint pack is configured to electrically interconnect corresponding busway segments of the longitudinally adjacent stacks of busway segments.

According to a further aspect, a modular busway power distribution system includes a busway including a plurality of busway segments arranged end-to-end and electrically interconnected with one another via one or more stack joint packs positioned between longitudinally adjacent busway segments, wherein each busway segment comprises a segment housing containing electrical buses, wherein each busway segment is configured to mount one or more mechanical joint blocks configured to mechanically couple at least one additional busway to form a stacked configuration of busways, and wherein the busway power distribution system is configured to be expanded by mechanically coupling the at least one additional busway to the busway using the one or more mechanical joint blocks.

### BRIEF DESCRIPTION OF THE DRAWINGS

Implementations of the present disclosure disclosed herein may be better understood when consideration is given to the following detailed description thereof. Such description refers to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 is a bottom, isometric view of a busway system including multiple (e.g., two in the illustrated embodiment) stacks of busways electrically interconnected using a stack joint pack, with at least one busway being an open track busway, in accordance with an example embodiment of the present disclosure;

FIG. 2 is a top, isometric view of the busway system shown in FIG. 1, in accordance with an example embodiment of the present disclosure;

FIG. 3 is a top, isometric view of a single stack of connected busway segments, in accordance with an example embodiment of the present disclosure;

FIG. 4 is a cross-sectional view of the single stack of connected busway segments shown in FIG. 3, in accordance with an example embodiment of the present disclosure;

FIG. 5 is an exploded, isometric view of the single stack of busway segments shown in FIG. 3, in accordance with an example embodiment of the present disclosure;

FIG. 6 is an isometric view of a mechanical joint block, in accordance with an example embodiment of the present disclosure;

FIG. 7 is a side view of the mechanical joint block shown in FIG. 6, in accordance with an example embodiment of the present disclosure;

FIG. 8 is a top, isometric view of a single stack of busway segments wherein the upper busway segment is a closed track busway, in accordance with an example embodiment of the present disclosure, in accordance with an example embodiment of the present disclosure;

FIG. 9 is a bottom, isometric view of the single stack of busway segments shown in FIG. 8, wherein the lower busway segment is an open track busway, in accordance with an example embodiment of the present disclosure;

FIG. 10 is a cross-sectional view of the single stack of busway segments shown in FIG. 8, in accordance with an example embodiment of the present disclosure;

FIG. 11 is a bottom, isometric view of a multiple (e.g., two in the illustrated embodiment) stack of busway segments including rolled copper busbars, wherein at least the lower busway segment is an open track busway, in accordance with an example embodiment of the present disclosure, in accordance with an example embodiment of the present disclosure;

FIG. 12 is a cross-sectional view of the single stack of busway segments shown in FIG. 11, in accordance with an example embodiment of the present disclosure;

FIG. 13 is a top, isometric view of a busway system including stacks of busway segments as shown in FIG. 11 electrically interconnected using a stack joint pack, wherein at least the bottom busway has an open track configuration, in accordance with an example embodiment of the present disclosure;

FIG. 14 is an end perspective view of a stack joint pack for facilitating electrical couplings between stacks of busways segments, in accordance with an example embodiment of the present disclosure;

FIG. 15 is an end view of a triple stack of busway segments connected using mechanical joint blocks, in accordance with an example embodiment of the present disclosure; and

FIG. 16 is an end view of a quad stack of busway segments connected using mechanical joint blocks, in accordance with an example embodiment of the present disclosure.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. The following detailed description is, therefore, not to be taken in a limiting sense.

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

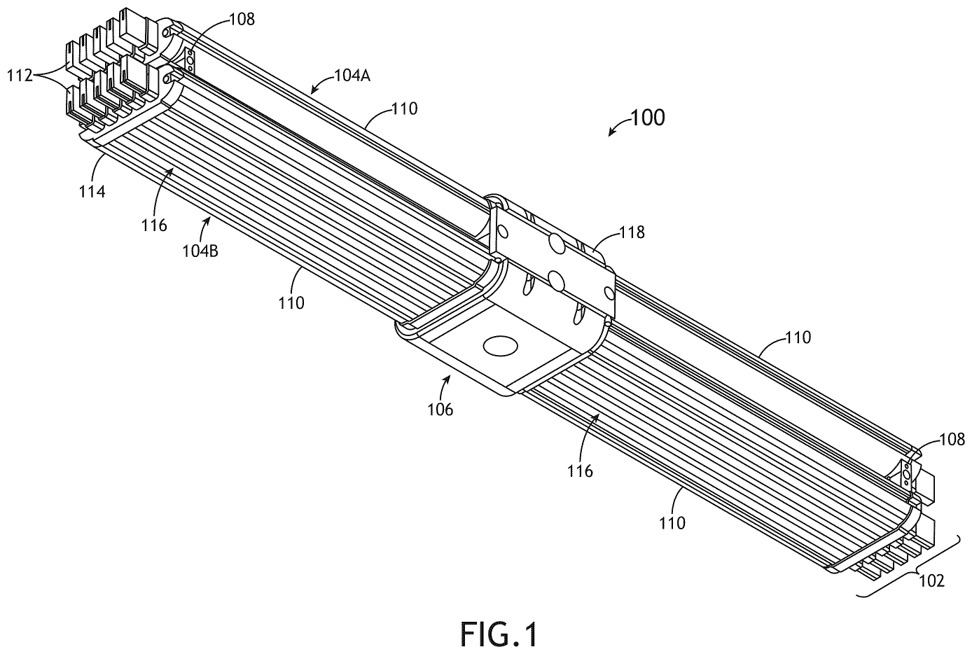

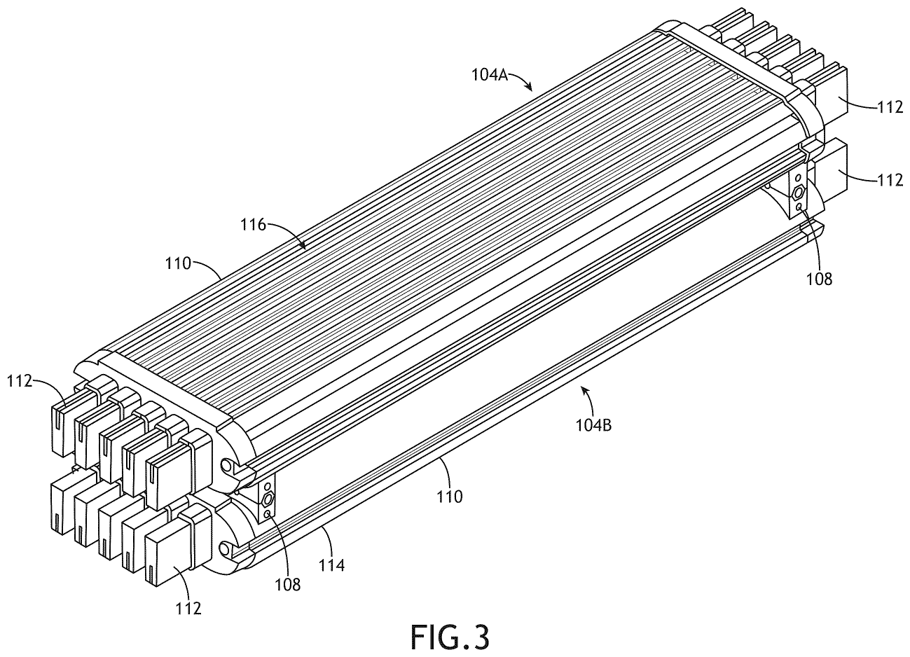

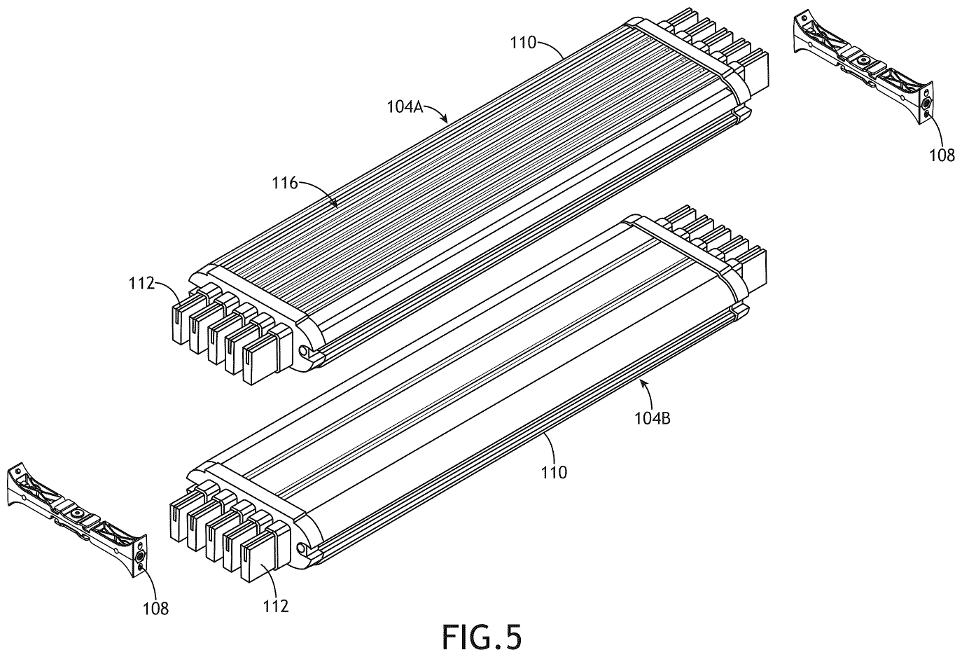

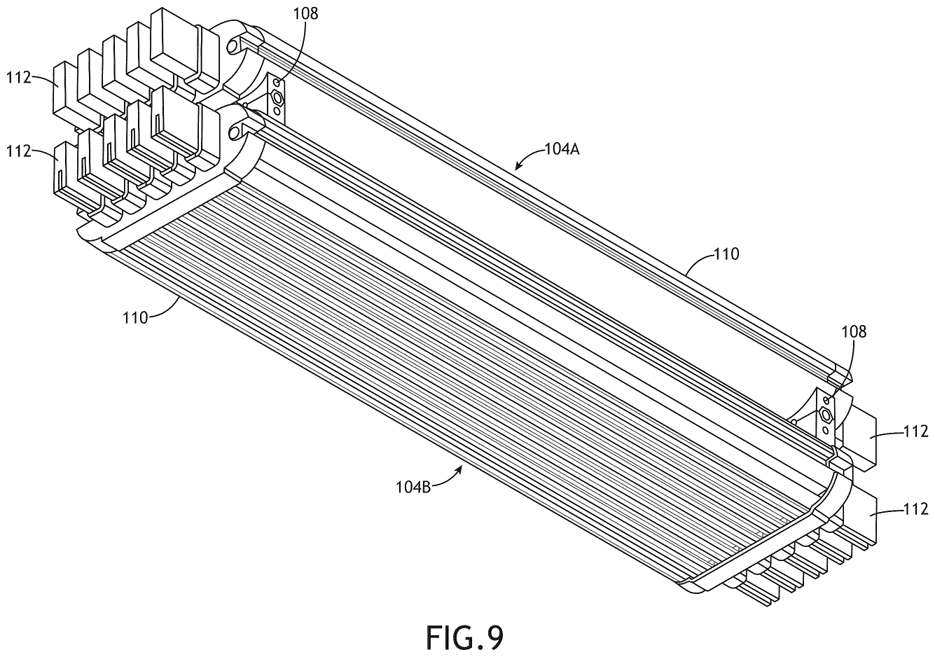

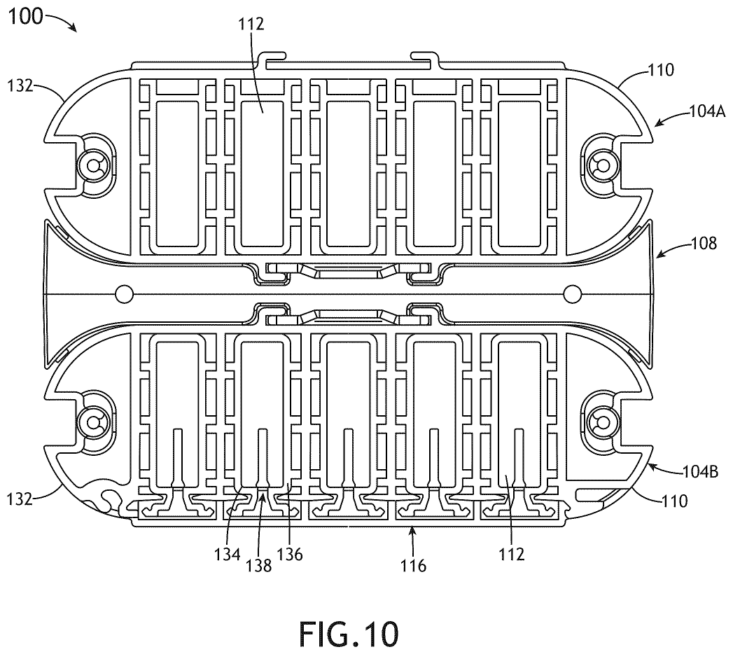

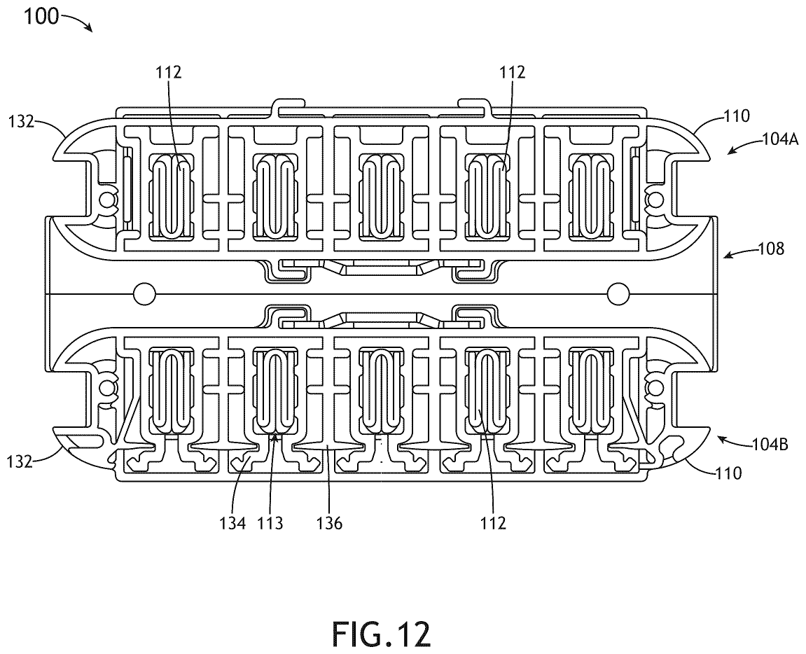

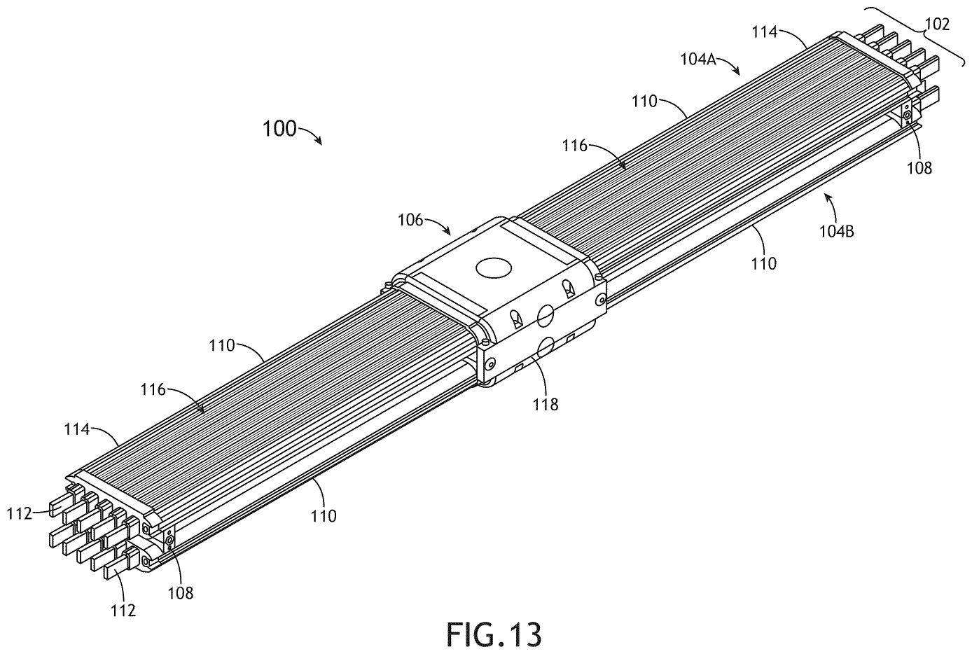

A multiple stack, open track busway system, as shown collectively in FIGS. 1-16, is configured to address the challenge of yielding a higher available amperage, thereby providing the necessary power capacity for evolving GPU requirements while maintaining adaptability and scalability in industrial settings. This solution aims to cater to the increasing power demands of modern computing systems without sacrificing ease of installation and future expansion possibilities. In an embodiment, a double stack of busways can be provided with at least one being an open track busway, but it is to be understood that three or more busways may be provided in a stack, with at least one being an open track busway. In embodiments, each busway is configured to provide multiple buses (e.g., 3-8) together configured to facilitate power transmission and/or data communication therethrough.

The increased power capacity within the stack is provided by electrically interconnecting the busways of the stack using one or more stack joint packs. In embodiments, each stack joint pack is configured to mechanically and electrically interconnect the respective busways and provide fixing points for joint side covers and additional hanging bracket mounting position options along the main busway length. In embodiments, each stack joint pack facilitates a direct electrical interconnect between the busways associated with the given stack joint pack, while the housing of the given stack joint pack is configured to yield the necessary electrical shielding between the sets of busbars within the associated busways, as well as around the interconnected busbars, overall.

In embodiments, one or more mechanical joint blocks can be implemented between an adjacent pair of busways or busway segments. In embodiments, each mechanical joint block serves multiple functions. First, each mechanical joint block is configured to connect, via a set of connecting plates associated therewith, two respective channels of the corresponding adjacent busways, thereby vertically supporting the adjacent busways relative to one another (e.g., hang relative to one another via the plates). Further, each end of a given mechanical joint block is configured to carry a pair of grab screws, each respective grab screw oriented toward one of the opposing busways, with the four grab screws of the mechanical joint block working together to hold the opposing open track busways longitudinally (e.g., along the relative length of each busway) in place relative to the other. In embodiments, each mechanical joint block may further define a pair of mounting positions (e.g., threaded through holes) in opposite distal end faces thereof.

The present multiple stack, open track solution is configured to enable open track connection of one or more high density tap offs anywhere along the length of the stack where an open track section is present. In an embodiment, tap off placement may be limited by the placement of the one or more stack joint packs that block access to the open track and the availability of open track on a given busway (e.g., a chosen busway may only be a bus carrier and not have an open track). The provision of multiple busways facilitates a multiplier effect on the available current (e.g., amperage) compared to a single busway set up. For example, the multiplier effect can be a 2X Underwriter's Laboratory (UL) rating multiplier or a 1.8 IEC rating multiplier when considering a double stack configuration (e.g., 1800 A-2250 A available IEC; 1600 A-2000 A available UL). For example, the multiple stacking of the busways and the related electrical interlinking thereof permits an increase in the ampere rating of each busway in the stack, thereby facilitating keeping up with rack densification yet still allowing flexibility in tap off unit placement.

In accordance with an embodiment of the present disclosure, a busway system includes multiple busways, one or more stack joint packs, and one or more mechanical joint blocks. In embodiments, the multiple busways define a stack of busways, with each busway including a respective plurality of busway segments. In embodiments, each busway includes multiple buses and a segment housing, the segment housing configured to carry and electrically insulate the buses from one another. In embodiments, one or more busways define an open track therein to facilitate electrical coupling with one or more tap off boxes. In embodiments, the one or more stack joint packs electrically couple with the busways, with each joint stack pack selectably electrically interconnecting a plurality of pairs of busway segments. In embodiments, the one or more mechanical joint blocks are configured to be mounted between an adjacent pair of the busways, with a first busway located above and carrying a second busway below via a corresponding mechanical joint block.

FIGS. 1-5 illustrate a multi-stack, open track busway system 100 (which may be referred to hereinafter as the busway system 100, for short), in accordance with an example embodiment of the present disclosure. The busway system 100 generally includes a multiple (two shown in the illustrated embodiment) stack of busways 102, for instance first and second busways 104A, 104B, one or more stack joint packs 106 (of which one is illustrated), and multiple mechanical joint blocks 108. The illustrated busway system 100 as shown includes a first (top/upper) busway 104A and a second (bottom/lower) busway 104B as part of its multiple (e.g., double, as illustrated) stack 102.

In embodiments, each busway 104A, 104B includes multiple busway segments 110 where each busway segment 110 includes one or more buses 112 and a concordant segment housing 114 configured to carry the buses 112 and electrically insulate the buses 112 from one another and a surrounding environment. Each busway segment 110 is mechanically and electrically coupled (particularly electrically coupling select buses 112) to one another via the one or more stack joint packs 106, as well as being ultimately coupled to a source of power (not shown). Per the illustrated embodiment, both busways 104A, 104B define an open track 116 (e.g., through a corresponding segment housing 114 and facilitating electrical coupling with one or more buses 112) configured to facilitate electrical coupling of a set of buses 112 of a corresponding busway 104A, 104B to one or more high-density tap off boxes (not shown). While the busway system 100 shows a double stack busway system, it is to be understood that the busway system 100 can be expanded to include three or more busways 104 with the stack joint pack 106 being expanded accordingly to electrically interconnect and house the concordant buses 112.

In embodiments, the one or more stack joint packs 106 electrically couple with the busways 104A, 104B (specifically, the buses 112 thereof), respectively spaced at periodic intervals when more than one such pack 106 is employed, as well helping to mechanically house them, as well. In an embodiment, each stack joint pack 106 is configured to interconnect a first pair of busway segments 110 associated with the first busway 104A and a second pair of busway segments associated with the second busway 104B. In an embodiment where three or more busways 104 are involved, there can, of course, be multiple pairs of busway segments 110 associated with the respective busways selectably interconnected (e.g., within vertical bus rows) within each stack joint pack 106. The ability to electrically couple the busways will be shown more later with respect to another embodiment, but it is to be understood that the concepts of that latter embodiment extend to this current one, as well as others presented throughout this disclosure.

The ability to electrically couple the respective buses 112 (e.g., of the busway segments 110) of the busways 104A, 104B at periodic intervals via the one or more stack joint packs 106 yields a higher available amperage (e.g., double or nearly double) within a given busway 104 than what would be available via a single such open-track busway. In an embodiment, such stack joint packs 106 may be spaced at intervals of about 10-15 feet along the first, second busway 104A, 104B, with each stack joint pack 106 respectively interconnecting two pairs of busway segments 110 (e.g., within a vertical column of a double stack configuration). In an embodiment, the spacing of such stack joint packs 106 may be determined based on the electrical requirements of the busway system 100 (e.g., spaced to avoid any electrical overloading while minimizing the cost of including further stack joint packs 106 beyond what is needed to meet the electrical requirements of the system). In embodiments, each stack joint pack 106 may further define a pack housing 118 configured to electrically insulate the electrical connections therein from one another and from the surrounding environment, as well as receiving a set of corresponding ends of the busway portions 110 therein. In embodiments, the pack housing 118 may be made of plastic, composite, or other insulating material that is also sufficiently mechanically durable.

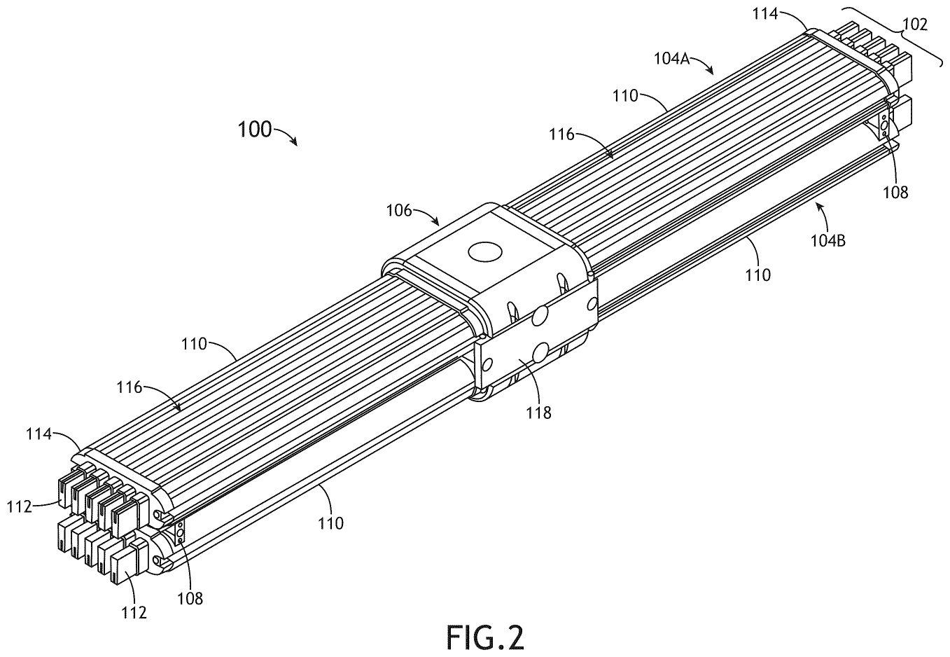

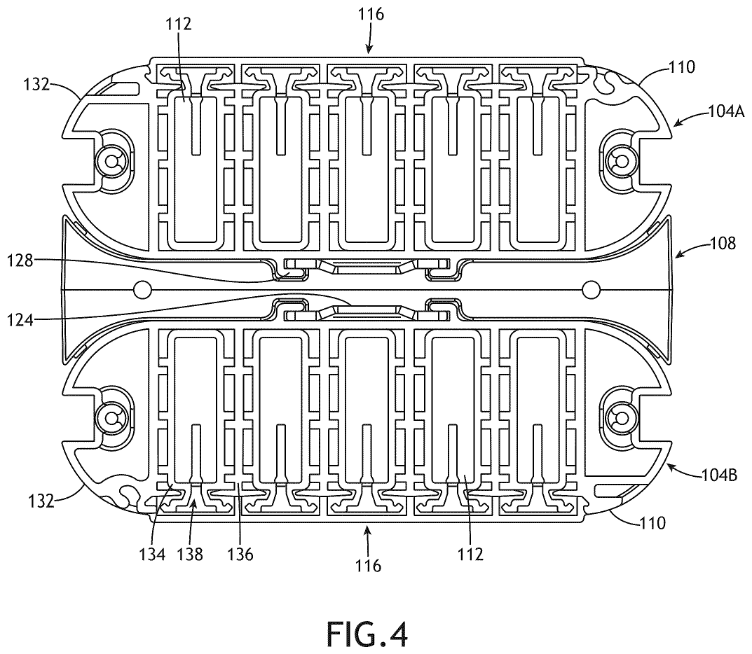

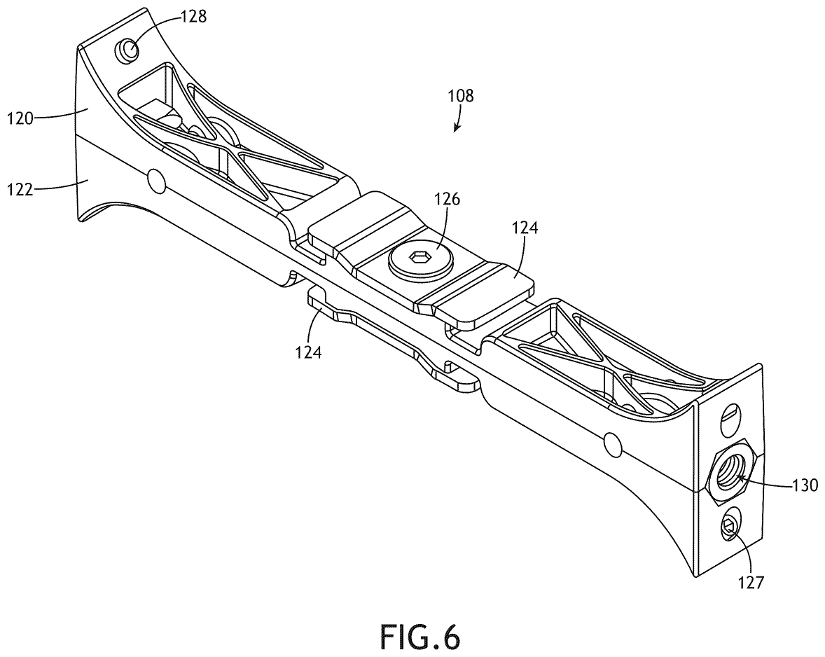

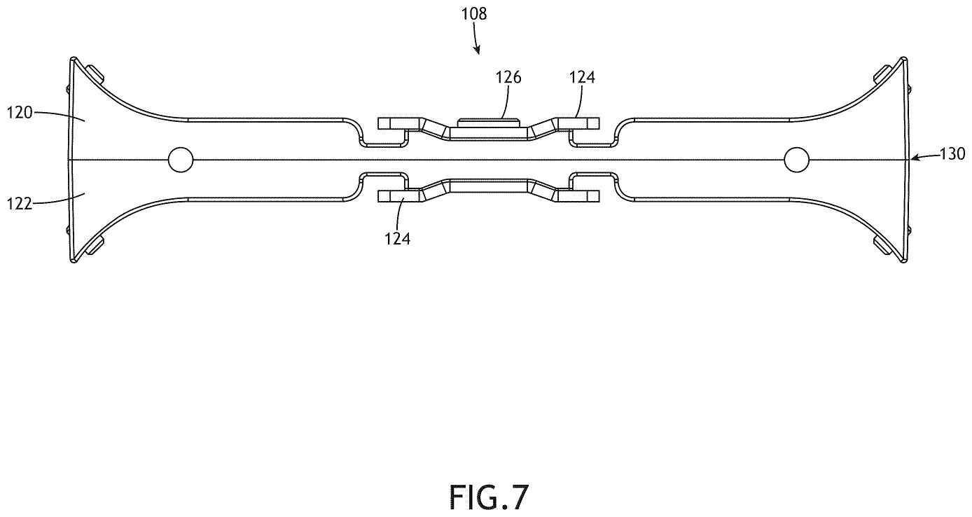

Each mechanical joint block 108, as expressly shown, for example, in FIGS. 4-7, is configured to be mounted between an adjacent pair of busways 104A, 104B, either a proximate stack joint pack 106 (e.g., as shown in FIGS. 1 and 2) or at a position away from a given stack joint pack 106. Each mechanical joint block 108, as best seen in FIGS. 6 and 7, may include a first joint block section 120, a second joint block section 122, a set of mounting plates 124, a section connector 126, multiple grab screws 127, and a set of distal face mounting ports 130. In an embodiment, the section connector 126 may extend through each of the first joint block section 120, the second joint block section 122, and the set of mounting plates 124, thereby holding the assembly together. In an embodiment, the section connector 126 may be a threaded connector or other elongate connector capable of interconnecting the desired parts together.

Each mounting plate 124, as best seen in FIG. 4, may be respectively held by and between a corresponding pair of mounting tabs 128 extending from a given busway 104A, 104B or, more specifically, a concordant segment housing 114 (e.g., where a pair of mounting tabs 128 essentially define a mounting slot therebetween). In an embodiment, where the busways 104A, 104B are aligned generally parallel to a floor, the mounting tabs 128 and the interconnecting section connector 126 permit the weight of the lower busway 104B to be carried by the upper busway 104A. It is to be understood that a given lower busway 104B may be carried by an upper busway 104A (e.g., or a first set of busway portions 110 carrying a second set thereof, depending on the vantage point), in sum, by multiple such interconnecting combinations, given that multiple mechanical joint blocks 108 may, indeed, be employed between a pair of busways 104A, 104B.

FIG. 4 is a cross-sectional view of busway system 100 relative to the first busway 104A and the second busway 104B (or a set of busway segments 110) at a position where they are joined by a mechanical joint block 108. Each busway segment 110 of a respective busway 104A, 104B may include a busway casing 132, multiple insulating bodies 134, and multiple internal ribs 136, similar to what is illustrated in U.S. Patent Publication 2015/0311654 A1 (also now assigned to Vertiv Corporation), the contents of which are hereby incorporated by reference. The multiple insulating bodies 134 may be located within the busway casing 132 and may be configured to carry the respective buses 112 (e.g., busbars) therein. In the illustrated embodiment, the respective buses 112 may each be in a form of a slotted metal (e.g., aluminum or other conductive metal or alloy) bar configured to interconnect electrically with a conductor (not shown) associated with the tap box via a portion of the open track 116 (with the slotted portion thereof facing the open track 116). In an embodiment, the buses 112 may be an elongate metal portion. In an embodiment, the buses 112 may be formed via extrusion or forging, especially when using aluminum or aluminum alloys. In an embodiment, the buses 112 may be formed of rolled copper (illustrated later in relation to another embodiment). In some embodiments, some buses 112 may be slotted or not, depending on whether such buses 112 are to be positioned relative to an open track 116 (as shown later in other embodiments). The multiple internal ribs 136 may extend from and into the busway casing 132 and may be configured to retain the insulating bodies 134 within the busway casing 132 and otherwise space the insulating bodies 134 from one another. In an embodiment, the busway casing 132 may be formed by an extrusion or other forming process and may be formed of a metal (e.g., aluminum or steel), plastic, or composite. The busway casing 132 may specifically define one or more slots 138, and the slots 138 may each be in communication with a respective bus 112 to establish the open track 116 of a given busway 104A, 104B.

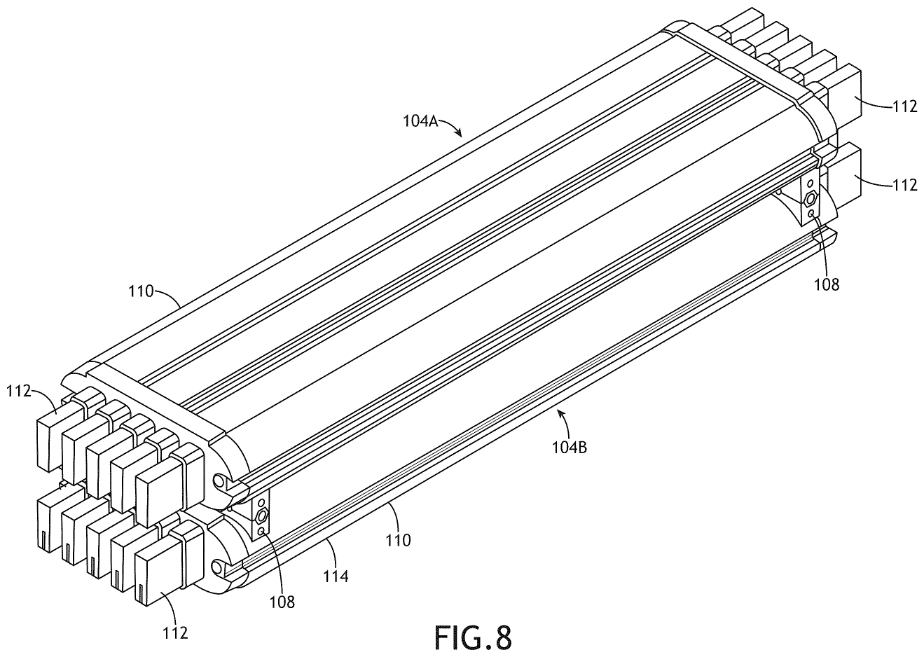

FIGS. 8-10 illustrate another version of a multi-stack, open track busway system 100, in accordance with an example embodiment of the present disclosure. The busway system 100 generally includes a multiple (two shown in the illustrated embodiment) stack of busway segments 110 of busways corresponding to upper and lower busways 104A, 104B secured together using spaced mechanical joint blocks 108, for instance two mechanical joint blocks 108 as shown. In the embodiment shown, the first busway 104A may have a closed busway 132 (e.g., closed track) whereas the second busway 104B may have an open track 116 formed in the casing. Per the illustrated embodiment, by providing a closed track on the first/upper busway 104A (e.g., without longitudinal slotting), the set of buses 112 positioned in at least some of the segments 110 of the first busway 112 are not required to be slotted considering their respective busway casing 132 does not facilitate installation of a tap off unit. That is, the set of buses 112 disposed in at least some of the segments 110 of the first busway 104A may be of a simpler, elongate strip design (e.g., reducing the cost thereof). Further, by limiting tap off unit electrical connection to the second (lower) busway 104B, the opportunity to electrically overload the system may be decreased (e.g., important since a system goal is to facilitate a higher available amperage). The difference in construction of the first and second busways 104A, 104B (e.g., open track on the lower busway 104B and the related bus construction) can be seen in each of FIGS. 8-10. While the busway system 100 shows a double stack busway system, it is to be understood that the busway system 100 can be expanded to include three or more busways with the stack joint pack being expanded accordingly to electrically interconnect and house the concordant buses 112, with, for example, the ‘lowest’ busway having an open track arrangement.

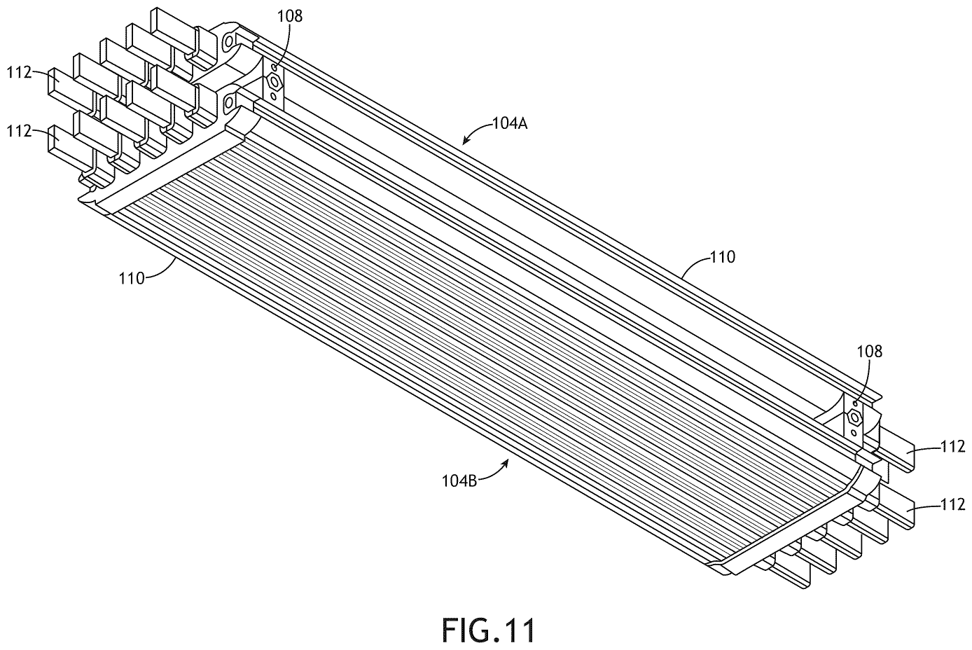

FIGS. 11-13 illustrate yet another version of a multi-stack, open track busway system 100, in accordance with an example embodiment of the present disclosure. The busway system 100 generally includes a multiple (two shown in the illustrated embodiment) stack 102 of busways 104A, 104B, one or more stack joint packs 106, and multiple mechanical joint blocks 108. The illustrated busway system 100 may include a first (top/upper) busway 104A and a second (bottom/lower) busway 104B as part of its multiple (e.g., double, as illustrated) stack 102. Each busway 104A, 104B may include multiple busway segments 110 where each busway segment 110 may include one or more buses 112 and a concordant segment housing 114 electrically insulating the buses 112 from one another and the environment. Each busway segment 110 may be mechanically and electrically coupled (particularly electrically coupling select buses 112) to one another via the one or more stack joint packs 10.

Per the illustrated embodiment, the busway system 100 may include multiple buses 112, with each bus 112 being a rolled metal construct. In an embodiment, each bus 112 may be a rolled copper, copper alloy, or tinned copper construct. In an embodiment, the rolled metal construct may approximate a “W” or “M” shape. In an embodiment, each bus 112, due to being roll-formed from sheet metal, may present an increased surface area for conduction (e.g., potentially improved electrical connectivity with one or more conductors associated with a given tap box). That is, the “W” or “M” shape of a given bus 112 may inherently yield a central, approximately U-shaped groove 113 configured to receive one or more conductors (e.g., from one or more tap boxes) therein, with any given bus 112 being compression-sealed proximate the distal ends thereof. Since the roll-forming process yields a rolled metal construct with a central U-shaped groove 113 therein, no further machining and/or processing thereof may be needed to yield an electrical interconnect groove therein.

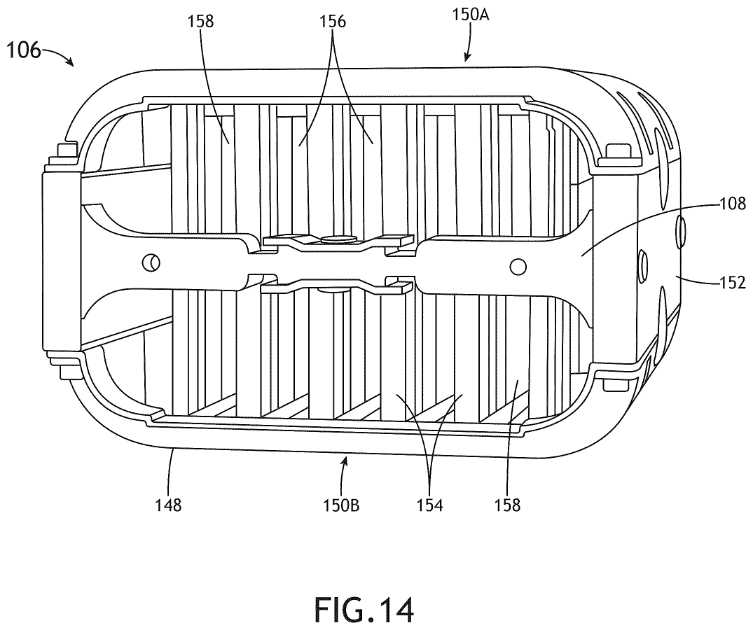

FIG. 14 illustrates an example of a stack joint pack 106 for electrically coupling buses associated with connected multiple stacks 102. Specifically, the stack joint pack 106 is used to electrically couple the buses 112 in aligned sets of busway segments, as well as mechanically house the exposed portions of the buses 112 presented at the ends of the segments 110. In embodiments, each stack joint pack 106 generally includes a pack housing 148 including, for example, a first housing 150A and a second housing 150B interconnected by opposing sidewalls 152. Within the pack housing 148, a plurality of parallel insulative dividers 154 define a plurality of distinct conductor channels 156 therebetween each including at least one bridge bus 158 for facilitating electrical coupling between sets of the buses 112 of the aligned segments 110. The pack housing 106 electrically insulates the distinct conductor channels 156 from one another and from the surrounding environment, as well as receiving sets of corresponding ends of the busway segments 110 therein. With respect to the multiple (e.g., double) stack 102, the distinct conductor channels 156 permit a respective pair of busways 104A, 104B to be electrically interconnected to one another within the stack joint pack 106, thus ultimately extending the busway length and yielding a higher available amperage within each busway 104A, 104B than what may otherwise be available without the presence of such stack joint packs 106.

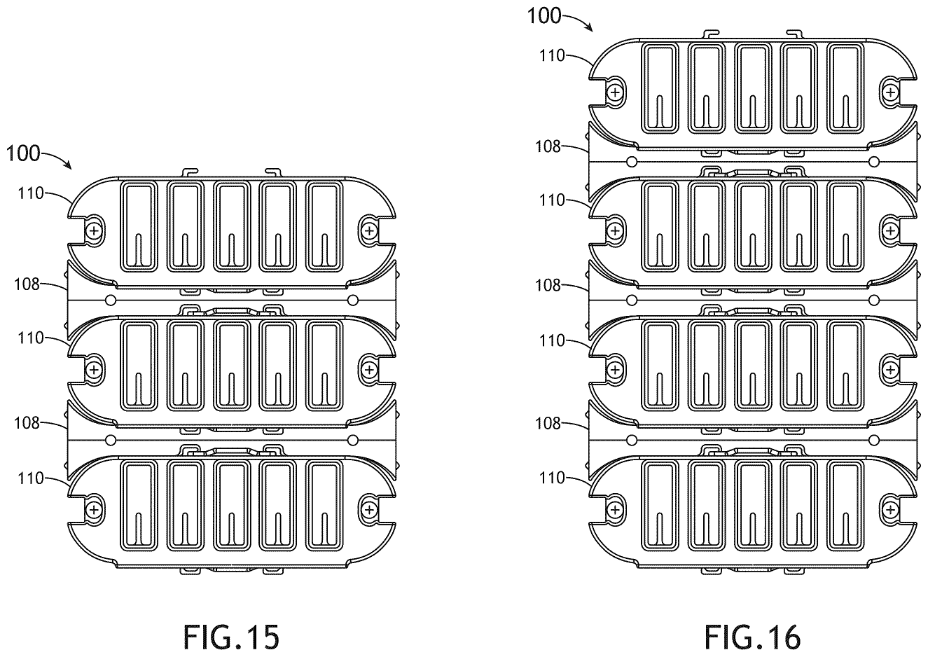

FIGS. 15 and 16 are end views of respective triple and quad versions of stacked busways of the busway system 100. In the triple stack configuration illustrated in FIG. 15, three separate busway segments 110 are shown connected using two separate mechanical joint blocks 108 to form a vertical stack of three busways. In the quad stack configuration illustrated in FIG. 16, four separate busway segments 110 are connected using three separate mechanical joint blocks 108 to form a vertical stack of four busways. Although not shown, each triple stack may be electrically coupled to at least one other like triple stack using at least one stack joint pack 106 having a triple stack joint pack configuration. Likewise, each quad stack may be electrically coupled to at least one other like quad stack using at least one stack joint pack 106 having a quad stack joint pack configuration. The stack joint packs 106 may be built in height by increasing the ‘height’ of the sidewalls 152 or by connecting a number of separate sidewalls 152 together.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Additionally, it is to be understood that the various embodiments presented herein can be considered collectively and not necessarily as completely distinct from one another, unless otherwise expressly stated. That is, it is to be understood that elements from the various embodiments may, indeed, be “mixed and matched” with one another where not specifically precluded.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A busway system, comprising:
a plurality of busways arranged in a stacked configuration, each busway comprising a plurality of busway segments arranged end-to-end;
one or more stack joint packs electrically coupling the plurality of busway segments; and
one or more mechanical joint blocks mounted between adjacent busways of the plurality of busways.

2. The busway system of claim 1, wherein each busway segment comprises:
a plurality of electrical buses; and
a segment housing configured to contain the plurality of electrical buses and electrically insulate the plurality of electrical buses from one another.

3. The busway system of claim 1, wherein the stacked configuration comprises at least two busways and at least four busway segments.

4. The busway system of claim 1, wherein the stacked configuration comprises at least three busways and at least six busway segments.

5. The busway system of claim 1, wherein at least one of the plurality of busways defines an open track extending along a length of the busway configured to facilitate electrical coupling between the busway and one or more tap-off boxes.

6. The busway system of claim 1, wherein;
each stack joint pack is selectively installable and removable to enable reconfiguration of electrical interconnections between the busway segments; and
each stack joint pack is configured to electrically interconnect corresponding electrical buses of adjacent busway segments.

7. The busway system of claim 1, wherein the stacked configuration comprises a vertical stack in which an upper busway mechanically supports a lower busway via a plurality of the mechanical joint blocks.

8. The busway system of claim 1, wherein each mechanical joint block comprises:
a first joint block section;
a second joint block section;
one or more mounting plates;
a section connector extending through the first joint block section, the section joint block section, and the one or more mounting plates to secure the mechanical joint block as an assembled unit;
a plurality of grab screws; and
a plurality of distal face mounting ports.

9. The busway system of claim 1, wherein each mechanical joint block comprises:
a first joint block section;
a second joint block section;
one or more mounting plates;
a plurality of grab screws; and
a plurality of distal face mounting ports;
wherein the first joint block section and the second joint block section are separate or integrally formed.

10. The busway system of claim 1, wherein the plurality of busways comprises a lower busway having an open track configuration and one or more upper busways each having a closed track configuration.

11. The busway system of claim 1, wherein each busway is rated by Underwriter's Laboratory (UL) to carry a current of at least 1600 amps (A) due to the one or more stack joint packs being electrically coupled with the plurality of busway segments.

12. A busway system, comprising:
a plurality of stacks of busway segments, each stack comprising at least two busway segments arranged in a vertical stacked relationship;
one or more mechanical joint blocks mechanically coupling adjacent busway segments within each stack of busway segments; and
one or more stack joint packs positioned between longitudinally adjacent stacks of busway segments;
wherein each stack joint pack is configured to electrically interconnect corresponding busway segments of the longitudinally adjacent stacks of busway segments.

13. The busway system of claim 12, wherein each busway segment comprises:
a plurality of electrical buses; and
a segment housing configured to contain the plurality of electrical buses and electrically insulate the plurality of electrical buses from one another.

14. The busway system of claim 12, wherein each stack of busway segments comprises at least an upper busway segment and a lower busway segment mechanically coupled by at least two of the mechanical joint blocks.

15. The busway system of claim 12, wherein each mechanical joint block comprises:
one or more joint block sections;
two mounting plates; and
a plurality of grab screws for engaging the adjacent busways segments.

16. The busway system of claim 12, wherein the plurality of stacks of busway segments are configured to permit modular expansion by adding additional stacks of busway segments in a longitudinal direction via additional ones of the stack joint packs.

17. A modular busway power distribution system, comprising:
a busway comprising a plurality of busway segments arranged end-to-end and electrically interconnected with one another via one or more stack joint packs positioned between longitudinally adjacent busway segments;
wherein each busway segment comprises a segment housing containing electrical buses;
wherein each busway segment is configured to mount one or more mechanical joint blocks configured to mechanically couple at least one additional busway to form a stacked configuration of busways; and
wherein the busway power distribution system is configured to be expanded by mechanically coupling the at least one additional busway to the busway using the one or more mechanical joint blocks.

18. The modular busway power distribution system of claim 17, wherein each mechanical joint block comprises:
one or more joint block sections;
two mounting plates; and
a plurality of grab screws for engaging vertically adjacent busways segments.

19. The modular busway power distribution system of claim 17, wherein the busway defines an open track configured to facilitate electrical coupling between the busway and one or more tap-off boxes.

20. The modular busway power distribution system of claim 17, wherein the at least one additional busway comprises an open track or a closed track.
